(19) United States
(12) Patent Application Publication
(10) Pub. No.: US 2008/0317135 A1
(43) Pub. Date: Dec. 25, 2008

(54) Method For Compressing An Audio, Image Or Video Digital File By Desynchronization

(76) Inventor: Pascale epouse Gervais Loiseau, Paris (FR)

Correspondence Address: BROWDY AND NEIMARK, P.L.L.C.;624 NINTH STREET, NW, SUITE 300, WASHINGTON, DC, 20001-5303, US

(21) Appl. No.: 11/658,179

(22) PCT Filed: Jul. 23, 2004
(86) PCT No.: PCT/FR2004/001986

§ 371 Date: Jan. 23, 2007

(51) Int. Cl. H04N 7/26

(52) U.S. Cl. 375/240.26; 375/E07.026

(57) ABSTRACT

The invention concerns a method for reducing the size of raw or previously compressed data of a digital file from an audio and/or video source. It comprises an operational sequence including a step of desynchronizing original reading criteria of the file, said step involving the compression and the compacting of preserved data and a step of resynchronizing the desynchronized file enabling it to be viewed and/or read based on its original criteria of resolution and duration.

This invention relates to a method of reducing the size of raw data or compressed data in a digital file, for example such as an audio file (characterised by its duration), a video file (characterised by its duration and its resolution) and an image file (characterised by its resolution).

It is particularly but not exclusively applicable to optimisation of data compression for existing or future software or hardware encoders or decoders and optimisation of storage supports for timed or untimed digital data.

It is particularly adapted to any hardware that already receives digital data compacted by known compression systems or any hardware ready to broadcast audio or video digital files using a known or future coding system.

In general, it is known that timed video media depend on time, their reproduction imposing elementary presentation actions regulated by time quanta. These timed media depend on their duration, expressed by a fixed number of samples per second for audio, and by a number of images per second for video.

The “display duration” of each sample, determined over one second, determines the duration and quality of the audio file. The combination of the total number of images (length) and the number of images per second (frame rate) generates the display duration of each video image and consequently the total duration of the video and then the total volume of data to be compacted.

This is why coding of a so-called timed digital file also obeys the duration rule, to the extent that the bit rate characterising the encoding quality is expressed in bytes per second or in kbits per second. Thus, an audio file with a duration of 60 seconds encoded at 128 kbps will always occupy 960 kbytes, regardless of the source quality and the amount of information contained in it. Even compression methods using variable bit rate algorithms are expressed in bytes per second.

The invention is particularly intended to solve the problems that arise due to increased optimisation of the compression rate of digital files, previously compressed or not compressed, without any additional perceptible quality degradation.

To achieve this, it discloses a method for reducing the size of raw data or previously compressed data in a digital file originating from an audio and/or a video source including the following steps:
a step to desynchronise the original read criteria for the file including compression and compaction of the conserved data, and
a resynchronisation step of the desynchronised file for its display and/or listening according to its resolution and original duration criteria.

If the method according to the invention concerns a timed digital file, it may more precisely include the following steps:
deregulation of time quanta of the file using a predetermined deregulation coefficient so as to shorten the file duration and the number of items of data to be processed,
recording of the deregulated file (accelerated),
reproduction of the file in accordance with a process including:
   detection of the deregulation coefficient, reproduction of original quanta by multiplying the duration of the processed file by the inverse of the regulation coefficient,
   production of digital values reproduced on an appropriate scale with a pitch corresponding to the deregulation coefficient so as to obtain a processed file with codes (calorimetric or audio) conforming with the codes for the source.

Thus, for a video file, the above-mentioned deregulation is obtained:
either by modifying the value of the quanta separating each image in the uncompressed file header,
or by copying each video image into the same time space according to the deregulation coefficient,
or by concentrating a series of images.

On the other hand, in the case of an audio file, deregulation takes place by modifying the pitch and/or concentrating the samples and/or deleting samples using a fixed or variable deletion rate.

In all cases, the method is used to reproduce the small file in its original time quanta, so as to enable correct execution without any additional perceptible quality degradation.

In reducing the length of the character string, it facilitates an increase in the time and spatial redundancy content.

By desynchronising the fundamental criteria for reading an uncompressed image file, it produces a principle for variable elimination of values for each colour layer and for each block of 64 values, as a function of the linearity of the information per row or per column and/or as a function of the proximity of the information.

Desynchronisation of the original resolution criteria using this method then reduces the size of a block up to 32 times its original resolution, depending on the characteristics of the values of these blocks.

Furthermore, desynchronisation of the original read criteria by deletion or by adaptive concentration of data can reduce the duration of timed audio and video media leading to a large reduction in the number of items of information to be coded and consequently requiring a smaller consumption of bits. Thus, the size of an “MPEG 1 layer 3” file for which the original read criteria were deregulated by 3, is three times smaller than a file not processed by the method according to the invention, for an equivalent quality.

Desynchronisation by concentration of a determined number “N of data” by simple means or by weighted means can reduce the total character string to be coded and for video can reduce the number of colour combinations, consequently creating an additional content of time or spatial redundant data.

Therefore, the method according to the invention enables known algorithms to deliver higher compression ratios, because it gives a file for which the digital data enable better optimisation.

As already mentioned, the method according to the invention is adaptable to any timed digital audio and/or video file for which data are already compressed or raw. In this case, the method is:
Either a mechanism to reduce the size of digital audio and video data optimising the compression factors of known encoding systems. The method then modifies the uncompressed source on which the system will act. The method then behaves like a module for pre-processing a source that will be encoded by compression systems for which the method can help to optimise some functions.
Or a complement to further reduce the size of a previously encoded digital audio file. It then modifies the compressed file. It behaves like a post compression module and is defined as a super compression tool designed to reduce the size of a previously compressed digital file.

Obviously, the method according to the invention can be adapted to any untimed digital file for which the data are not compressed and that will be reduced by a proprietary format.

It includes an adapted audiovisual player for reproducing the image, audio and video file according to its original resolution and duration criteria.

Compared with traditional file size reduction methods, the method according to the invention has the following advantages:

Firstly, every image file is defined by a fixed resolution represented by its height and by its width, and for which the ratio expresses the total number of digital data to be processed, for each colour layer. The reduction in the volume of information to be processed by the reduction in the image resolution is usually fixed and proportional to the original resolution. Furthermore, known variable data reduction systems only process successive redundant values.

On the contrary, the method according to the invention proposes to reduce the total volume of condensable information for each colour layer by a variable reduction of image data without respecting image homothety. Secondly, by priority, it reduces the different data sequences and possibly compacts the redundant data sequences. It is equally applicable to fixed images and animated images.

One example embodiment of the method according to the invention will be described below, non-limitatively, with reference to the appended drawings in which:

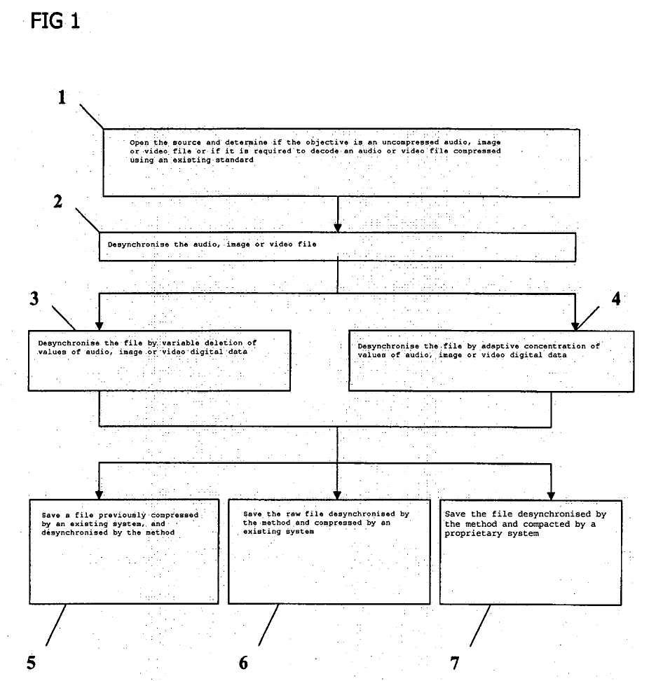

FIG. 1 is a schematic representation showing the desynchronisation steps of the audio, image or video file;

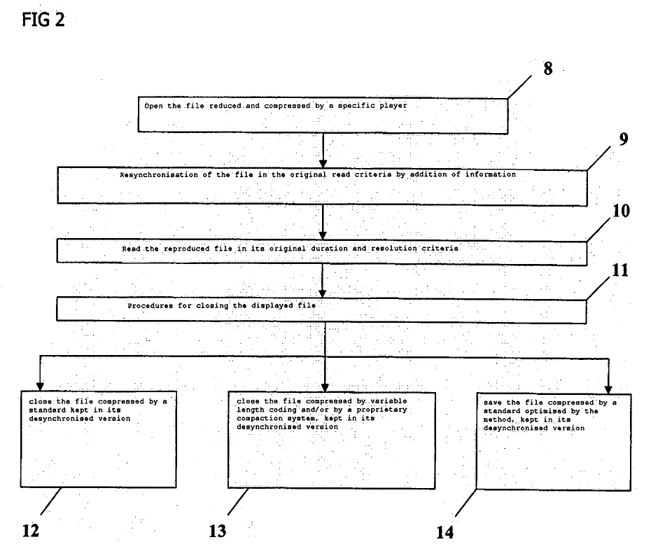

FIG. 2 is a schematic representation showing the resynchronisation steps of the audio, image or video file;

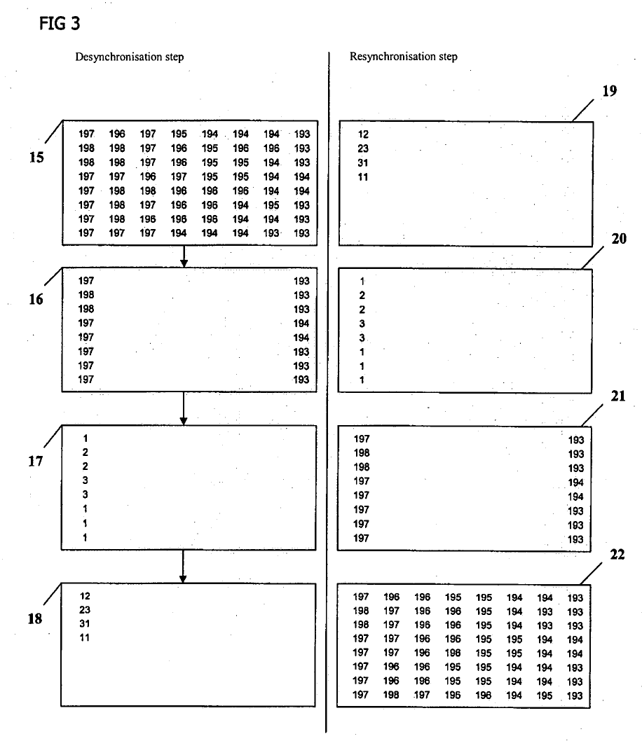

FIG. 3 shows a desynchronisation and resynchronisation mode for an image data block.

As shown in FIG. 1, the desynchronisation method for an audio, image or video file includes the following steps:

A first step to open the file; it is determined whether the file is an uncompressed audio, image and/or video file, or if it is an audio and video file already compressed by an existing system, for example of the audio Mpeg or video Mpeg type (block 1).

A second step that represents the two methods of reducing the size of the audio and/or video file by desynchronisation of their original read criteria (block 2).

Two methods of desynchronising the original read criteria are used depending on the required processing speed, resources of the support used for processing, the required reproduction quality level and the complexity of the colour components of all or some of the video file and/or variation levels between the different channels characterising the audio file; these two methods are desynchronisation by variable deletion of values of digital audio and video data (block 3), and desynchronisation by adaptive concentration of values of audio and/or video data (block 4).

Each of the two methods can be applied to all values of digital data in the audio and/or video file considered, or these two methods can be applied at the same time to all or some of the audio and/or video file for which the resolution and consequently the size are to be reduced.

The Desynchronisation Method by Variable Deletion of Values of Digital Audio, Image and/or Video Data (Block 3).

Desynchronisation of the original criteria for reading audio and/or video data by deletion of digital data values (block 3) consists of deleting a number “N of data” using a variable coefficient used to reduce the original duration of the file and to reproduce said number “N of data” when listening to the audio file or displaying the image and/or video file.

The number “N of data” means the number of deleted audio samples, the number of deleted images or the number of groups of images deleted in a video or the number of different digital values deleted in an image or in a sequence of images.

During the reproduction phase, the number “N−1 of data” means the number of audio samples to be reproduced, the number of images to be reproduced or the number of groups of images to be reproduced in a video or the number of different digital values to be reproduced in an image in order to reproduce the audio, image and/or video file in its original reproduction criteria.

The deletion coefficient Cs of “N data” appears in the file header or in the header of the group of samples, the group of images and/or the group of digital values for which it indicates the number of data to be added to the reproduction. This coefficient is used for setting parameters of the formula to add missing data that is essential to reproducing the file in its original read criteria. A data group is reproduced using the following procedure:

Consider a data group to be reproduced V₁, V₂, V₃ . . . Vₙ.

A coefficient IR to reproduce missing information is determined using the following formula

$$IR = \frac{{V}_{n} - {V}_{1}}{{C}_{S} + 1}$$

The next step is to reproduce the missing data V₂ to Vₙ−1 starting from the previous calculated value IR, using the following iterative formula

$${V}_{2} = {V}_{1} - IR$$

$${V}_{3} = {V}_{2} - IR$$

$$…$$

$${V}_{n} - 2 = {V}_{n} - 3 - IR$$

$${V}_{n} - 1 = {V}_{n} + IR$$

Desynchronisation of the original read criteria is applicable to any audio and/or video file compressed by existing compression standards, to all or part of an audio, image and/or video uncompressed file to be reduced by a proprietary compression format and characterised by low amplitudes, to all or part of an image file for which the values or groups of values are characterised by near and linear values, and to all or part of video files for which plan changes are infrequent.

### The Method of Desynchronisation of Read Criteria by Adaptive Concentration of Values of Digital Data (Block 4).

Desynchronisation of original read criteria by adaptive concentration of audio and/or video data (block 4) consists of using a fixed coefficient to concentrate a number of “N audio samples”, a number of “N images” or a number “N of image groups” of a video and finally to concentrate a number “N of digital values” of an image using a fixed or variable coefficient.

The fixed coefficient appears in the file header, while the variable coefficient appears in the header of the group of concentrated values for which it indicates the number of data to be recomposed during the reproduction phase.

Desynchronisation by adaptive concentration of values of digital data of all or part of an audio, image and/or video file is done using two types of data concentration, namely concentration by simple average and concentration by an adaptive weighted average.

Concentration of the number “N of data” by simple average is applicable to all or some of the values of digital data of all or part of an audio, image and/or video file, characterised by average amplitudes or low movement scenes. Since only the concentrated value representing “N data” is conserved, the number of samples in the audio file, the number of images or the number of the group of images in the video file and/or the number of values or the number of groups of values in the image file was reduced by the data concentration coefficient(s).

The formula for the simple average M_{S} is as follows:

$${M}_{S} = \frac{{\sum }_{n = 1}^{N} x ( n )}{N}$$

in which x(n) represents the first processed value.

The concentration of “N data” by adaptive weighting average is used for all or part of the audio file comprising large amplitudes and all or part of the video files characterised by large numbers of plan changes and/or movement scenes.

An adaptive weighting average is the concentration of “N data” weighted with reference to a precise value for which the position can vary in the group of concentrated values.

The concentration formula by weighted average M_{P} is as follows:

$${M}_{P} = \frac{{\sum }_{n = 1}^{N} a ( n ) * x ( n )}{{\sum }_{n = 1}^{N} a ( n )}$$

in which a(n) represents the coefficient of the processed value x(n).

Blocks 5, 6 and 7 describe three possibilities for saving any desynchronised audio, image and/or video file, depending on whether it is a file previously compressed by an existing system (block 5), an uncompressed file desynchronised by the method and compressed by an existing system (block 6) and an uncompressed file, desynchronised by the method and compressed by a proprietary system (block 7).

FIG. 2 shows the four steps in resynchronisation of an audio, image and/or video file desynchronised by the method.

Block 8 represents the phase in which the file is open by a specific audio, image and/or video player distinguishing if it is a desynchronised digital file compressed by an existing system or by a proprietary format.

Block 9 shows the resynchronisation phase by addition of samples, by addition of values, by addition of images and/or groups of missing images in order to reproduce the audio, image and/or video file in its original read criteria.

The formula applied to the addition phase is done using a player capable of decoding and reading the desynchronised file in real time.

The formula for addition of information necessary for resynchronisation depends on the coefficient of the number “N of data” deleted during the desynchronisation phase of the read criteria, but is also indistinctly applicable if it is a variable deletion of audio and/or video data and/or desynchronisation of audio and/or video data by adaptive concentration.

Block 10 represents the read phase of the audio, image and/or video file reproduced by the player in its original read criteria.

Blocks 11, 12 and 13 characterise the closing phase of the listened and/or displayed file (block 11) depending on whether it is required to keep the file compressed by a standard according to its shorten duration (block 12), keep the file compressed by a proprietary format according to its reduced duration (block 13), or save the compressed file by a standard according to its original resolution (block 14).

FIG. 3 shows an example desynchronisation and resynchronisation of a block of image data 15 comprising 64 values comprising 8 columns of 8 values between 193 and 198.

The first desynchronisation step consists of verifying that the difference between the minimum and maximum of values is less than or equal to 21. If this is the case, then desynchronisation can be done.

If this is the case, the first value and the last value of each row that is stored in an associated table (block 16) are considered and a specific number is assigned to each distinct combination (block 17). The last operation consists of grouping and memorising the numbers of combinations in pairs (block 18) so as to store each group of combination numbers on a single byte (for example the combination of numbers 1 and 2 becomes 12).

The first step of the inverse phase (resynchronisation) (block 19) consists of reading the previously memorised grouped combination numbers.

These combination numbers (block 20) are dissociated so as to obtain combination numbers corresponding to the first data and the last data on each row (block 21).

Knowing the first and last number on each row and the number of numbers per row, the difference between each of these pairs of numbers is determined and the result of this difference is divided by the number of numbers between this pair of numbers to obtain the interval (pitch) between two consecutive numbers. The previously calculated interval is subtracted from the first number and the integer value of this difference is assigned to the second number, the same method is used to establish the value of the third number and so on until the last number. The result is thus a block of resynchronised data for which the values are very close or even the same as the original values (block 22).

It can be seen with this method that the boundaries (first and last number of each row) are identical to the original boundaries and therefore no degradation is introduced between the data blocks.

One advantage of this solution is the compaction of combination numbers stored on a byte in pairs or in threes, until all 256 values have been used enabling coding on eight bits.

Another advantage of this solution is that it can be used to obtain high processing speeds and can thus save processor resources.

1. Method of reducing the size of raw data or previously compressed data in a digital file originating from an audio and/or a video source,
comprising an operating sequence including the following steps:
a step to desynchronise the original read criteria for the file including compression and compaction of the conserved data, and
a resynchronisation step of the desynchronised file for its display and/or listening according to its original resolution and duration criteria.

2. Method according to claim 1,
comprising deregulation of time quanta of the file using a predetermined deregulation coefficient so as to shorten the file duration and the number of items of data to be processed,
recording of the deregulated file (accelerated),
reproduction of the file in accordance with a process including:
detection of the deregulation coefficient,
reproduction of original quanta by multiplying the duration of the processed file by the inverse of the regulation coefficient,
production of digital values reproduced on an appropriate scale with a pitch corresponding to the deregulation coefficient so as to obtain a processed file with codes (calorimetric or audio) conforming with the codes for the source.

3. Method according to claim 2,
wherein for a video file, deregulation is obtained:
either by modifying the value of the quanta separating each image in the uncompressed file header,
or by copying each video image into the same time space according to the deregulation coefficient.

4. Method according to claim 2,
wherein the case of an audio file, deregulation takes place by modifying the pitch.

5. Method according to claim 3,
comprising reduction of the total volume of condensable information for each colour layer by a variable reduction of image data without respecting image homothety, reduction of the different data sequences then possibly compaction of redundant data sequences.

6. Method according to claim 5,
wherein for desynchronising the fundamental criteria for reading an uncompressed image file, it includes variable elimination of values for each colour layer and for each block of 64 values as a function of the linearity of the information per row or per column and/or as a function of the proximity of the information.

7. Method according to claim 6,
wherein desynchronisation of the original characters includes reduction of the size of blocks up to 32 times their original resolution, depending on the characteristics of the values of these blocks.

8. Method according to claim 1, wherein the original read criteria are desynchronised by deletion or by adaptive concentration of data so as to reduce the duration of timed media.

9. Method according to claim 1, comprising desynchronisation by concentration of <<N data>> by simple average or by weighted average so as to reduce the total character string to be coded and, for video, to reduce the number of colour combinations resulting in the creation of an additional content of time or spatial redundant data.

10. Method according to claim 1, being used as a module for pre-processing a source to be encoded by compression systems.

11. Method according to claim 1, being used as a post-compression module so as to reduce the size of a previously compressed digital file.

12. Method according to claim 8, comprising deletion of a number “N of data” using a variable deletion coefficient appearing in the file header, or in the header of a group of samples, a group of images and/or a group of digital values for which it indicates the number of data to be added to the reproduction, this coefficient being used for setting parameters of a formula to add missing data used to reproduce the file in its original read criteria.

13. Method according to claim 9, wherein desynchronisation consists of concentrating “N audio samples”, a number of “N of images” or a number “N of image groups” of a video using a fixed coefficient, and concentrating a number “N of digital values” of an image using a fixed or variable coefficient, the fixed coefficient appearing in the file header, while the variable coefficient appears in the header of the group of concentrated values for which it indicates the number of data to be recomposed during the reproduction phase.
